(19) United States
(12) Patent Application Publication
(10) Pub. No.: US 2005/0262701 A1
(43) Pub. Date: Dec. 1, 2005

(54) Utility knife having safe locking device

(76) Inventor: Chao Hsien Lai, Taichung (TW)

Correspondence Address: Chao Hsien LAI, P.O. Box 63-298, Taichung, 406, TW

(21) Appl. No.: 10/858,532

(22) Filed: May 29, 2004

(51) Int. Cl. B26B 1/04

(52) U.S. Cl. 30/161

(57) ABSTRACT

A utility knife includes a housing having two plates secured together, to form a space between the plates, a knife blade has one end rotatably secured to the plates, to allow the knife blade to rotate out of the housing toward a working position or to rotate into the space of the housing toward a storing position. A latch is movably received in the plates and engageable into and out of a lock notch of the knife blade, to selectively lock the knife blade to the plates at the working position. A spring member may bias the latch into the notch of the knife blade, and to selectively lock the knife blade to the housing at the working position.

### BACKGROUND OF THE INVENTION

1. Field of the Invention

The present invention relates to a utility knife, and more particularly to a utility knife having a safe locking device to safely lock the knife blade of the utility knife in place, and to prevent the knife blade from being closed inadvertently.

2. Description of the Prior Art

Typical tool devices or utility knives comprise one or more knife blades pivotally or rotatably attached or received in a casing, and openable and extendible out of the casing to an outward working position, and rotatable and receivable in the casing at an inward receiving or storing position.

For example, U.S. Pat. No. 6,460,698 to Wang discloses one of the typical tool devices including a utility knife assembly having one or more knife blades pivotally or rotatably attached or received in a casing, and also openable and extendible out of the casing to an outward working position, and rotatable and receivable in the casing at an inward receiving or storing position.

However, the typical utility knife assembly has no safely locking devices to safely lock the knife blades to the casing, such that the knife blade may have a good chance to be rotated and received into the casing inadvertently, and such that the fingers of the users may have a good chance to be hurt or cut by the knife blade inadvertently, particularly when the knife blade is rotated and received into the casing.

The present invention has arisen to mitigate and/or obviate the afore-described disadvantages of the conventional utility knives.

### SUMMARY OF THE INVENTION

The primary objective of the present invention is to provide a utility knife including a safe locking device to safely lock the knife blade of the utility knife in place, and to prevent the knife blade from being closed inadvertently.

In accordance with one aspect of the invention, there is provided a utility knife comprising a housing including a first and a second plates secured together, to define a space between the first and the second plates. A knife blade includes a cutter edge, and includes a first end rotatably secured to the first and the second plates of the housing with a shaft, to allow the knife blade to rotate out of the housing toward a working position or to rotate into the space of the housing toward a storing position, the knife blade including a notch formed in the first end thereof. A latch is movably received in the first and the second plates of the housing, and engageable into and out of the notch of the knife blade, to selectively lock the knife blade to the first and the second plates of the housing at the working position when the latch is engaged into the notch of the knife blade. A spring biasing device may further be provided for biasing the latch toward the first end of the knife blade, to selectively force the latch to engage into the notch of the knife blade, and to selectively lock the knife blade to the housing at the working position.

The latch may be engaged into the notch of the knife blade, to selectively lock the knife blade to the plates of the housing at the working position, and to solidly and safely lock the knife blade to the plates of the housing, and to prevent the knife blade from being rotated relative to the housing from the working position to the receiving or storing position, or from being closed inadvertently, in order to prevent users from being cut or hurt by the knife blade inadvertently.

The latch includes a first end rotatably secured to the first plate of the housing with an axle, to allow the latch to be rotated relative to the housing. The first plate includes a groove formed therein to rotatably receive the axle, and to rotatably secured the latch to the first plate of the housing. The first plate includes a board attached thereto, to enclose the groove thereof, and to engage with the axle, and to stably retain the axle in the first plate of the housing.

The board includes an oblong hole formed therein, to slidably receive the latch. The board includes an orifice formed therein, the first plate includes a peg extended therefrom, to engage into the orifice of the board, and to anchor the board to the first plate.

The second plate includes an oblong hole formed therein, to slidably receive the latch. The second plate includes a board attached thereto and having an oblong hole formed therein, to slidably receive the latch. The second plate includes a depression formed therein, the biasing device includes a spring member received in the depression of the second plate, and engaged with the latch, to bias the latch toward the first end of the knife blade.

The second plate includes a peg extended into the depression thereof, the spring member is engaged with the peg of the second plate. The second plate includes a fastener secured thereto, the spring member includes a first end engaged with the fastener. The latch includes a hand grip attached thereto, to move the latch relative to the first and the second plates of the housing.

The knife blade includes at least one pin secured thereto, and located at the first end thereof, to engage with the first and the second plates of the housing, and to limit a rotational movement of the knife blade relative to the first and the second plates of the housing.

The housing includes at least one spacer disposed between the first and the second plates, to define the space between the first and the second plates. Each of the first and the second plates includes a depression formed therein, the spacer includes two end projections engaged into the depressions of the first and the second plates, to anchor and to position the spacer between the first and the second plates.

The spacer includes a peripheral recess formed therein, to receive the cutter edge of the knife blade. The knife blade includes a cavity formed in the first end thereof, to selectively receive the latch, and to selectively retain the knife blade at the storing position.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a utility knife in accordance with the present invention, in which the knife blade is rotated or opened or extended out of the housing to an outward working position;

FIG. 2 is a plan view of the utility knife, in which a portion of the housing is removed to show an inner structure of the utility knife;

FIG. 3 is an exploded view of the utility knife;

FIG. 4 is a partial perspective view showing a portion of one half of the housing of the utility knife;

FIG. 5 is a partial perspective view illustrating the folding operation of the utility knife;

FIG. 6 is a plan view of the utility knife as shown in FIG. 5;

FIG. 7 is a perspective view of the utility knife, in which the knife blade is rotated or closed or extended into the housing to an inward receiving or storing position; and

FIG. 8 is a plan view of the utility knife as shown in FIG. 7.

### DETAILED DESCRIPTION OF THE PREFERRED EMBODIMENT

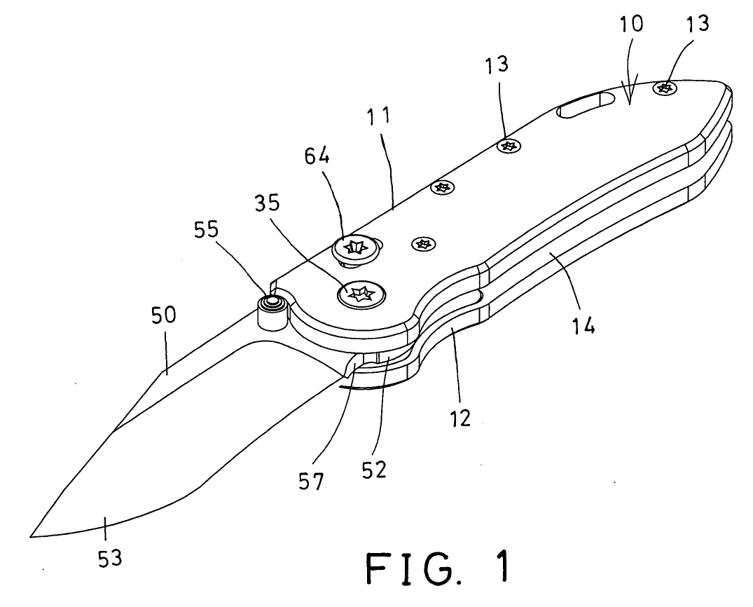

Referring to the drawings, and initially to FIGS. 1-4, a utility knife in accordance with the present invention comprises a handle or a housing 10 including two plates 11, 12 secured together with such as fasteners 13, and one or more spacers 30 disposed between the plates 11, 12 and secured to the plates 11, 12 with the fasteners 13, to suitably space the plates 11, 12 away from each other for a distance or a gap or a space 14 (FIGS. 1, 5, 7).

For example, each of the spacers 30 includes two end projections 31 for engaging into corresponding depressions 15 of the plates 11, 12, and thus for positioning the spacers 30 to the plates 11, 12, and each of the spacers 30 includes a screw hole 32 formed in each end thereof, for threading with the fasteners 13, and for solidly securing the spacers 30 between the plates 11, 12. Each of the spacers 30 preferably includes a peripheral recess 33 formed in the middle portion thereof.

Each of the plates 11, 12 includes a hole 16 formed in one end thereof for receiving a shaft 34 which may be rotatably secured to the plates 11, 12 with fasteners 35, and each of the plates 11, 12 includes a recess 17 formed in the one end thereof, and communicating with the hole 16 thereof, for receiving a board 40. Each of the boards 40 also includes a hole 41 formed therein for receiving the shaft 34.

The boards 40 may be made of metal or stronger materials, to allow the shaft 34 to be solidly coupled to the plates 11, 12 of the housing 10, and may further be solidly secured to the plates 11, 12 respectively with one or more fasteners 18. Each of the plates 11, 12 may further include one or more pegs 19 extended into corresponding orifices 42 of the boards 40 respectively, to further solidly anchor or secure the boards 40 to the plates 11, 12 respectively.

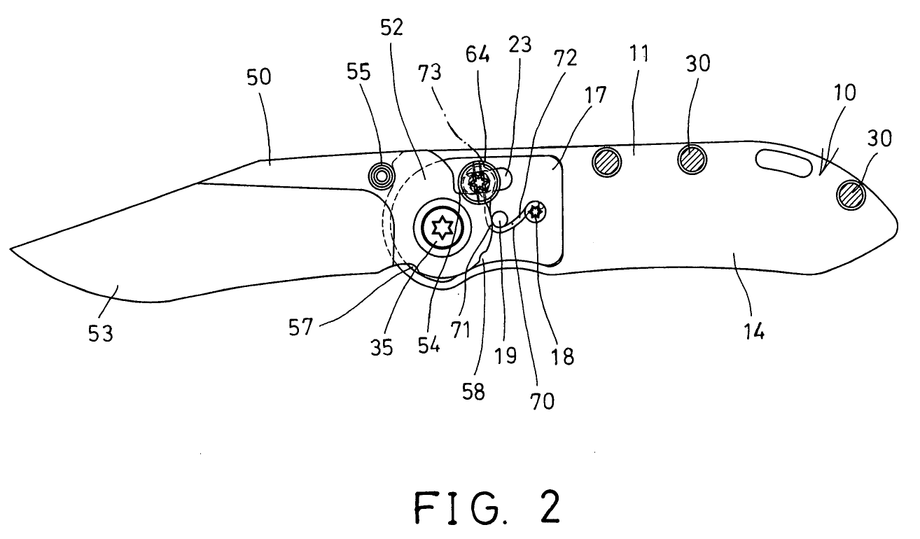

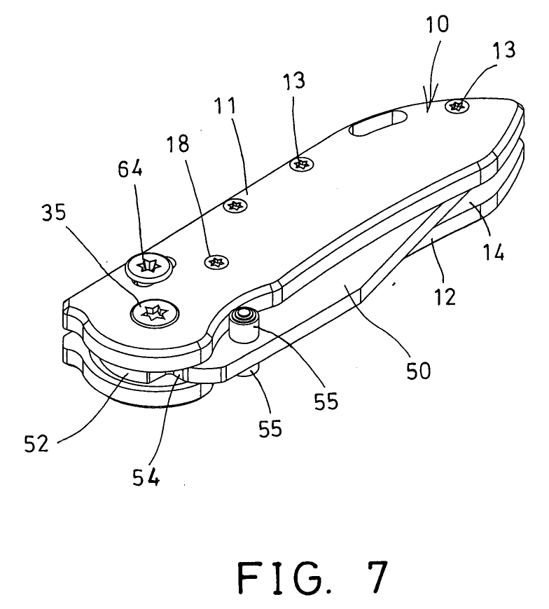

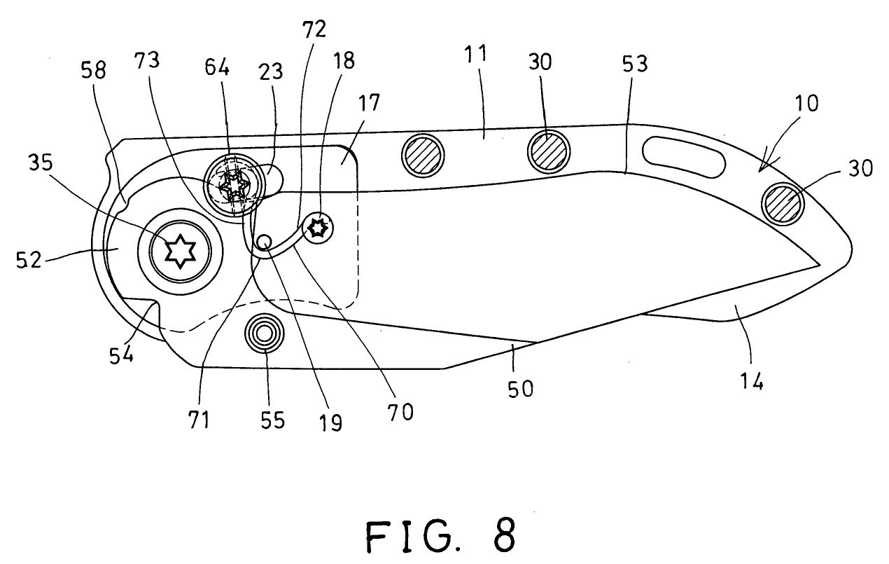

A knife blade 50 includes a hole 51 formed in one end 52 thereof for receiving the shaft 34, and for rotatably securing or attaching the knife blade 50 to the plates 11, 12 of the housing 10 with the shaft 34, and for allowing the knife blade 50 to rotate out of the plates 11, 12 of the housing 10 at a working position (FIGS. 1 and 2), and to rotate into the space 14 of the plates 11, 12 of the housing 10 at a receiving or storing position (FIGS. 7 and 8).

The knife blade 50 includes a cutter edge 53 for cutting purposes, and includes a lock notch 54 formed in the one end 52 thereof. One or more juts or pins 55 may be secured to the knife blade 50, located close to the one end 52 of the knife blade 50, to engage with the plates 11, 12 of the housing 10 (FIGS. 1 and 2), and thus to limit the rotational movement of the knife blade 50 relative to the plates 11, 12 of the housing 10, and/or to solidly retain the knife blade 50 at the working position (FIGS. 1, 2).

As shown in FIGS. 5, 6, and 8, the spacers 30 are preferably made of resilient rubber or composite or synthetic materials, for engaging with the cutter edge 53 of the knife blade 50, and for preventing the cutter edge 53 of the knife blade 50 from being directly engaged with the fasteners 13, and thus for protecting the cutter edge 53 of the knife blade 50. The peripheral recesses 33 of the spacers 30 may be provided to receive the cutter edge 53 of the knife blade 50.

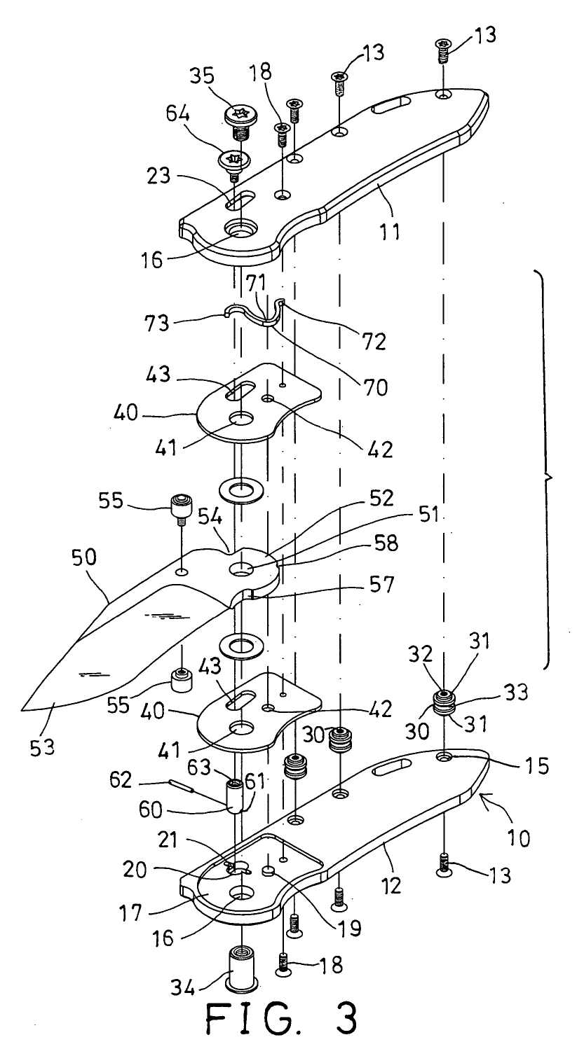

One of the plates 12 includes an opening 20 formed therein and communicating with the recess 17 thereof, and further includes a groove 21 formed therein and communicating with the recess 17 and the opening 20 thereof. It is preferable that the groove 21 of the plate 12 is laterally formed through or intersecting with the opening 20 of the plate 12, to form a cross structure, best shown in FIG. 3.

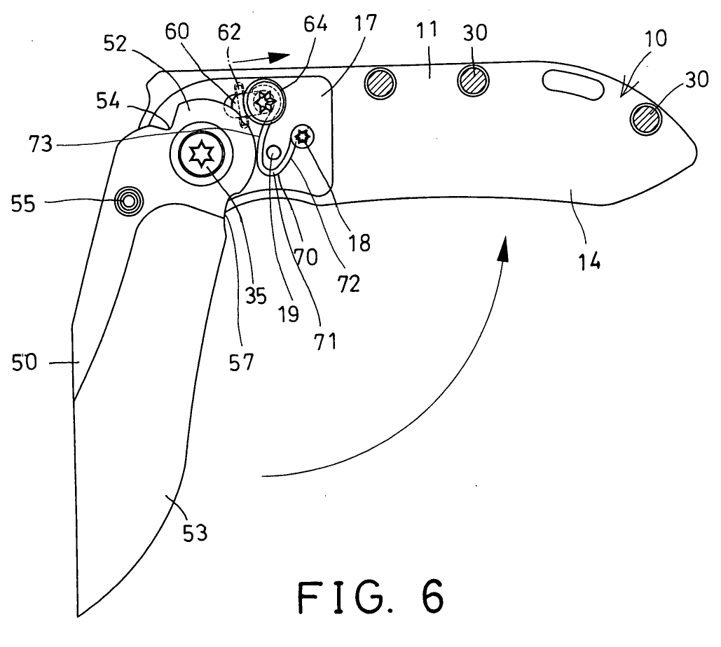

A latch 60 includes one end 61 engaged in the opening 20 of the plate 12, and includes an axle 62 attached to the one end 61 thereof and engaged into the groove 21 of the plate 12, to pivotally or rotatably attach the latch 60 to the plate 12, and to allow the latch 60 to be slightly pivoted or rotated relative to the plate 12 (FIGS. 5, 6). Each of the boards 40 includes an oblong hole 43 formed therein, and the other plate 11 also includes an oblong hole 23 formed therein, to slidably receive the latch 60, and thus to allow the latch 60 to be pivoted or rotated relative to the plates 11, 12 and the boards 40 (FIGS. 5, 6).

A fastener or a hand grip 64 may be engaged through the oblong hole 23 of the other plate 11, and secured to the other end 63 of the latch 60, to pivot or rotate or move or operate the latch 60 relative to the plates 11, 12. When the board 40 is engaged into the recess 17 of the plate 12, the board 40 may shield or enclose the groove 21 of the plate 12, and may engage with the axle 62, to stably and rotatably retain or secure the axle 62 to the plate 12, and to prevent the axle 62 from being disengaged from the plate 12.

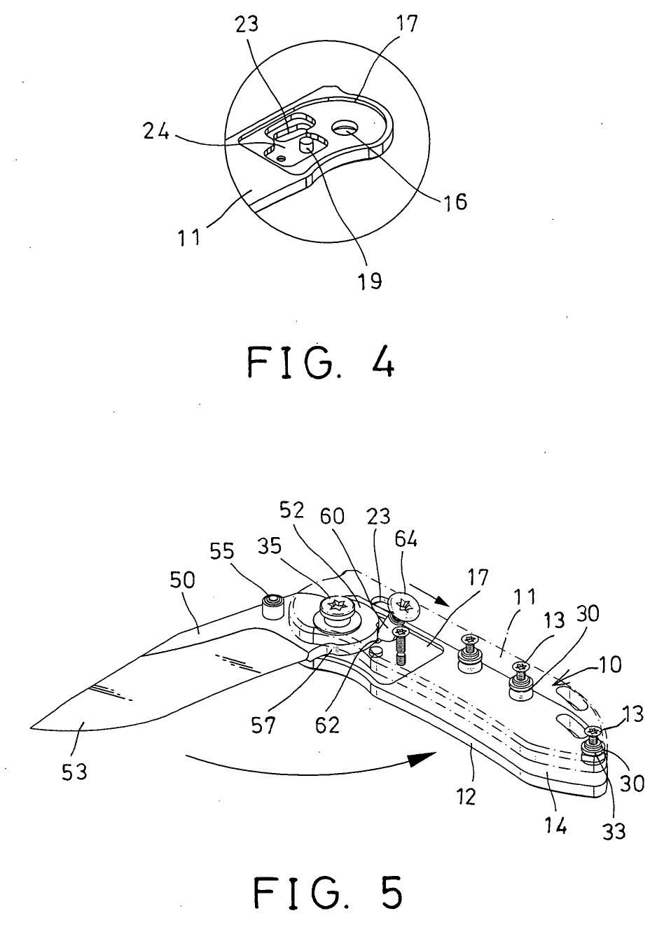

The plate 11 further includes a depression 24 formed therein (FIG. 4) and communicating with the recess 17 and the oblong hole 23 thereof, to receive a spring member 70 therein. When the board 40 is engaged into the recess 17 of the plate 11, the board 40 may shield or enclose the depression 24 of the plate 11, and may engage with the spring member 70, to stably receive and retain the spring member 70 within the depression 24 of the plate 11, and to prevent the spring member 70 from being disengaged from the plate 11.

The spring member 70 includes a middle portion 71 engaged around the peg 19 of the plate 11, and includes one end 72 engaged with the plate 11 or the fastener 18, and includes the other end 73 engaged with the latch 60, to bias the latch 60 toward the one end 52 of the knife blade 50, and/or to bias the latch 60 to engage into the lock notch 54 of the knife blade 50 (FIG. 2).

In operation, as shown in FIGS. 1 and 2, when the knife blade 50 is rotate out of the plates 11, 12 of the housing 10 at the working position, the latch 60 may be biased to engage into the lock notch 54 of the knife blade 50 (FIG. 2), and thus to lock or retain the knife blade 50 at the working position relative to the plates 11, 12 of the housing 10, and to prevent the knife blade 50 from being rotated relative to the plates 11, 12 of the housing 10 from the working position to the receiving or storing position (FIGS. 7 and 8) or from being closed inadvertently, in order to prevent users from being cut or hurt by the knife blade 50 inadvertently.

When it is required to rotate and receive the knife blade 50 into the space 14 of the plates 11, 12 of the housing 10, as shown in FIGS. 5 and 6, it is only required to move the fastener or hand grip 64 along the oblong hole 23 of the other plate 11, in order to rotate or to move the latch 60 against the spring member 70, and so as to disengage the latch 60 from the lock notch 54 of the knife blade 50, and thus to release the knife blade 50, and to allow the knife blade 50 to rotate relative to the plates 11, 12 of the housing 10 from the working position (FIGS. 1, 2) to the receiving or storing position (FIGS. 7 and 8).

It is preferable that the knife blade 50 further includes a cavity 57 formed in the one end 52 thereof (FIGS. 1-3 and 5-6), for receiving the latch 60 (FIG. 8), and thus to retain the knife blade 50 at the receiving or storing position (FIGS. 7 and 8). The knife blade 50 may further include one or more cavities 58 formed in the one end 52 thereof (FIGS. 2-3 and 8), for receiving the latch 60 (FIG. 5), and thus to retain the knife blade 50 at different positions other than the working position and the receiving or storing position.

Accordingly, the utility knife in accordance with the present invention includes a safe locking device to safely lock the knife blade of the utility knife in place, and to prevent the knife blade from being closed inadvertently.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A utility knife comprising:
a housing including a first and a second plates secured together, to define a space between said first and said second plates,
a knife blade including a cutter edge, and including a first end rotatably secured to said first and said second plates of said housing with a shaft, to allow said knife blade to rotate out of said housing toward a working position or to rotate into said space of said housing toward a storing position, said knife blade including a notch formed in said first end thereof,
a latch movably received in said first and said second plates of said housing, and engageable into and out of said notch of said knife blade, to selectively lock said knife blade to said first and said second plates of said housing at the working position when said latch is engaged into said notch of said knife blade, and
means for biasing said latch toward said first end of said knife blade, to selectively force said latch to engage into said notch of said knife blade, and to selectively lock said knife blade to said housing at the working position.

2. The utility knife as claimed in claim 1, wherein said latch includes a first end rotatably secured to said first plate of said housing with an axle, to allow said latch to be rotated relative to said housing.

3. The utility knife as claimed in claim 2, wherein said first plate includes a groove formed therein to rotatably receive said axle, and to rotatably secured said latch to said first plate of said housing.

4. The utility knife as claimed in claim 3, wherein said first plate includes a board attached thereto, to enclose said groove thereof, and to engage with said axle, and to stably retain said axle in said first plate of said housing.

5. The utility knife as claimed in claim 4, wherein said board includes an oblong hole formed therein, to slidably receive said latch.

6. The utility knife as claimed in claim 4, wherein said board includes an orifice formed therein, said first plate includes a peg extended therefrom, to engage into said orifice of said board, and to anchor said board to said first plate.

7. The utility knife as claimed in claim 1, wherein said second plate includes an oblong hole formed therein, to slidably receive said latch.

8. The utility knife as claimed in claim 7, wherein said second plate includes a board attached thereto and having an oblong hole formed therein, to slidably receive said latch.

9. The utility knife as claimed in claim 1, wherein said second plate includes a depression formed therein, said biasing means includes a spring member received in said depression of said second plate, and engaged with said latch, to bias said latch toward said first end of said knife blade.

10. The utility knife as claimed in claim 9, wherein said second plate includes a peg extended into said depression thereof, said spring member is engaged with said peg of said second plate.

11. The utility knife as claimed in claim 9, wherein said second plate includes a fastener secured thereto, said spring member includes a first end engaged with said fastener.

12. The utility knife as claimed in claim 1, wherein said latch includes a hand grip attached thereto, to move said latch relative to said first and said second plates of said housing.

13. The utility knife as claimed in claim 1, wherein said knife blade includes at least one pin secured thereto, and located at said first end thereof, to engage with said first and said second plates of said housing, and to limit a rotational movement of said knife blade relative to said first and said second plates of said housing.

14. The utility knife as claimed in claim 1, wherein said housing includes at least one spacer disposed between said first and said second plates, to define said space between said first and said second plates.

15. The utility knife as claimed in claim 14, wherein each of said first and said second plates includes a depression formed therein, said at least one spacer includes two end projections engaged into said depressions of said first and said second plates, to anchor and to position said at least one spacer between said first and said second plates.

16. The utility knife as claimed in claim 14, wherein said at least one spacer includes a peripheral recess formed therein, to receive said cutter edge of said knife blade.

17. The utility knife as claimed in claim 1, wherein said knife blade includes a cavity formed in said first end thereof, to selectively receive said latch, and to selectively retain said knife blade at the storing position.
